(19) United States
(12) Patent Application Publication
(10) Pub. No.: US 2009/0025977 A1
(43) Pub. Date: Jan. 29, 2009

(54) REMOVABLE CABLE GLAND

(76) Inventors: Timothy W. Anderson, Omaha, NE (US); Richard L. Case, Omaha, NE (US); Thomas Crain, Melissa, TX (US); Joseph C. Livingston, Frisco, TX (US); Gil Ruiz, McKinney, TX (US); Wade Womack, Allen, TX (US)

Correspondence Address: Muncy, Geissler, Olds & Lowe, PLLC, P.O. BOX 1364, FAIRFAX, VA, 22038-1364, US

(21) Appl. No.: 11/828,198

(22) Filed: Jul. 25, 2007

(51) Int. Cl. H02G 15/007

(52) U.S. Cl. 174/653

(57) ABSTRACT

A removable cable gland includes a two-piece fitting which may be laterally assembled over a cable, as opposed to a cable being fed through an opening in the fitting. A two-piece compression nut may also be laterally assembled over the cable. The two pieces of the compression nut are slid together along a longitudinal direction of the cable by a tongue and groove arrangement. The two pieces of the fitting are plugged together in a direction perpendicular to the longitudinal direction of the cable. Once first threads of the fitting are engaged to second threads of the compression nut, the two-piece fitting is locked together by the surrounding compression nut. Simultaneously, the two-piece compression nut is locked together, such that the tongue may not slide longitudinally relative to the groove, due to the first and second thread engagement.

### BACKGROUND OF THE INVENTION

1. Field of the Invention

The present invention relates to a cable gland, which may be employed on fiber optic cables, coaxial cables, twisted pair cables, or other types of cables or elongated objects. More particularly, the present invention relates to a cable gland having a two-piece fitting and two-piece compression nut, which can be assembled around any portion of a cable.

2. Description of the Related Art

Cable glands are well known in the existing arts. A cable gland is generally a structure which is mechanically fixed to an outer jacket of a cable, typically by a frictional fit or possibly an adhesive. The cable gland also has attachment features which allow the cable gland to be attached to a secondary object, such as a housing, plate, or guide. The cable gland thereby provides strain relief to the cable. In other words, a pulling force applied to the cable's jacket will be transmitted, via the jacket, to the cable gland and hence to the secondary object (e.g., housing). Therefore, the pulling force on the cable will not pass beyond the secondary object (e.g., into the housing to disturb a termination of the cable to the equipment within the housing).

FIG. 1 illustrates component parts of a prior art cable gland which have been loosely threaded onto a cable 13. FIG. 2 illustrates the component parts of the cable gland of FIG. 1 being connected together to secure the cable 13 to a secondary structure 10.

As seen in FIGS. 1 and 2, the cable 13 includes individual wires, each having an insulation layer 12 surrounding an electrical conductor 11. The secondary structure 10, such as a sidewall of equipment housing, is provided with an opening 14. A fitting 16 of the cable gland is formed as a generally cylindrical member. Located centrally on the fitting 16 is a projecting section 17, which serves as a retention feature. A first end of the fitting 16 has a first male thread 15. A retention nut 18 has a complimentary female thread and may be screwed onto the first end of the fitting 16 to sandwich the secondary structure 10 between the projecting section 17 and the retention nut 18, whereby the fitting 16 is secured to the secondary structure 10. A gasket or seal may be placed over the first male thread 15 between the projecting portion 17 and the secondary structure 10 to ensure a liquid-tight seal, if desired.

A second end of the fitting 16 is provided with a second male thread 20 for receiving a compression nut 21 having a complimentary female thread 25. A longitudinal bore through the fitting 16 is substantially uniform from the outer end of the first male thread 15 to a point intermediate the projecting section 17 and the outer end of the second male thread 20. Then, the bore is outwardly tapered at the compression nut end of the fitting 16 to form a conical seat 22. The conical seat 22 is similar in shape to a conical body portion 23 of a deformable gland 24. The gland 24 is formed of a resilient elastomer, such as Neoprene, and includes a bore 26 extending along its central axis. The bore 26 has a diameter which is slightly greater than the outer diameter of the largest cable 13 that the gland 24 is designed to accommodate.

When the gland 24 is placed in the fitting 16 without compression, the conical body portion 23 seats against the conical seat 22 of the fitting 16, and the gland 24 projects outwardly from the fitting 16 by about one-half of its length. When the gland 24 is axially compressed by screwing the compression nut 21 onto the second male thread 20, the gland wall defining the bore 26 presses tightly upon the outer jacket of the cable 13 and thereby seals that interface against the passage of liquid. Concurrently, the conical body potion 23 of the gland 24 compresses tightly in the conical seat 22 of the fitting 16 and seals that interface against the passage of liquid.

The outer end of the gland 24 may include a short taper 27. The short taper 27 matches an internal taper formed within the compression nut 21, as best seen in FIG. 2. Thereby, screwing the female thread 25 of the compression nut 21 onto the male thread 20 of the fitting 16 will press the gland 24 into the conical seat 22 of the fitting 16 and cause the gland 24 to seal against the internal surface of the compression nut 21, the conical seat 22, and the cable 13.

### SUMMARY OF THE INVENTION

The Applicants have appreciated one or more drawbacks associated with the designs of the prior art.

With cable glands of the prior art, the cable gland must be installed over the cable prior to terminating the cable. In other words, the component parts of the cable gland must be threaded over the cable 13 before the electrical conductors 11 are terminated to connectors. This requirement can be particularly troublesome in the case of preterminated cables.

Many customers of fiber optic cables prefer that the cables have factory installed terminals, such as ST-type or LC-type terminals, at each end. Customers may believe that factory installed terminals are of a higher quality than terminals installed by a field technician. Therefore, the customer may purchase standard length preterminated fiber optic cables, such as a 6 foot fiber optic cable having ST-type connectors at each end. If a field technician is required to install this preterminated fiber optic cable between two female connectors, there is no structure available in the existing art to permit a cable gland to be subsequently installed mid-span of the cable and used along the length of the preterminated cable.

One solution would be to preinstall the cable gland components onto the fiber optic cable at the factory prior to installing the two end terminals. However, this is not an optimum solution in that not all fiber optic cables will need a cable gland in the final installation and then the component parts go unused and are left dangling on the cable. This creates excess bulk in the cable management space and is seen as undesirable by the customer. Also, in some installations a single preterminated fiber optic cable may require two or more cable glands. It is not economically feasible for installers to inventory, store and carry multiple lengths of preterminated fiber optic cables with various numbers of loose cable gland parts preinstalled thereon.

The Applicants have appreciated a need in the art for a cable gland having component parts which can be installed laterally over any mid-span portion of a cable to permit a user to fix the cable to a secondary object, instead of having to thread a cable end through a bore within the component parts of the cable gland.

It is an object of the present invention to address one or more of the drawbacks of the prior art cable gland designs and/or Applicants' appreciated needs in the art.

This and other objects are accomplished by a removable cable gland including a two-piece fitting which may be laterally assembled over a cable, as opposed to a cable being fed through an opening in the fitting. A two-piece compression nut may also be laterally assembled over the cable. The two pieces of the compression nut are slid together along a longitudinal direction of the cable by a tongue and groove arrangement. The two pieces of the fitting are plugged together in a direction perpendicular to the longitudinal direction of the cable. Once first threads of the fitting are engaged to second threads of the compression nut, the two-piece fitting is locked together by the surrounding compression nut. Simultaneously, the two-piece compression nut is locked together, such that the tongue may not slide longitudinally relative to the groove, due to the first and second thread engagement.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a side view of component parts of a cable gland loosely assembled on a cable, in accordance with the prior art;

FIG. 2 is a partial cross sectional view of the cable gland of FIG. 1 attaching the cable to a secondary object, in accordance with the prior art;

FIG. 3 is a perspective view, from a compression nut side, of cable gland components, in accordance with the present invention;

FIG. 4 is a perspective view, from a retention nut side, of the cable gland components of FIG. 3;

FIG. 5 is an exploded view illustrating the two-part construction of several of the components of the cable gland;

FIG. 6 is a perspective view of the cable gland, from the retention nut side, with the components assembled;

FIG. 7 is a perspective view of the assembled cable gland of FIG. 6, from the compression nut side;

FIG. 8 is a cross sectional view taken along line VIII-VIII in FIG. 7;

FIG. 9 is a perspective view illustrating an attachment of cable glands to a secondary structure; and

FIG. 10 is a perspective view illustrating an optional washer in accordance with another embodiment of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

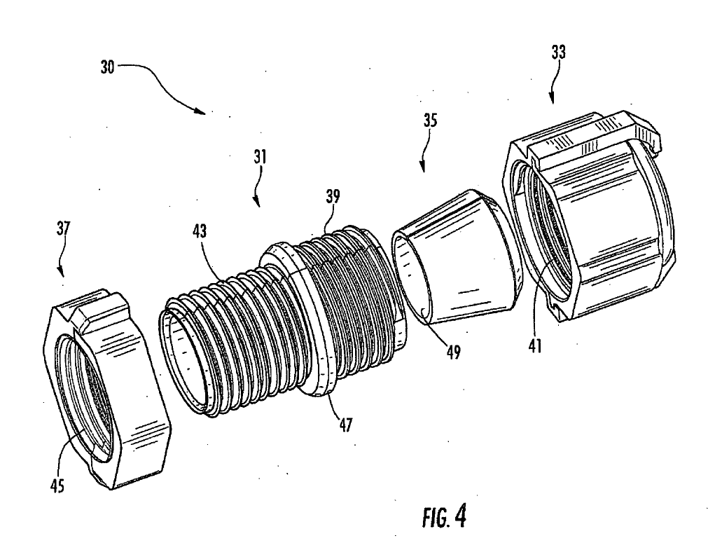

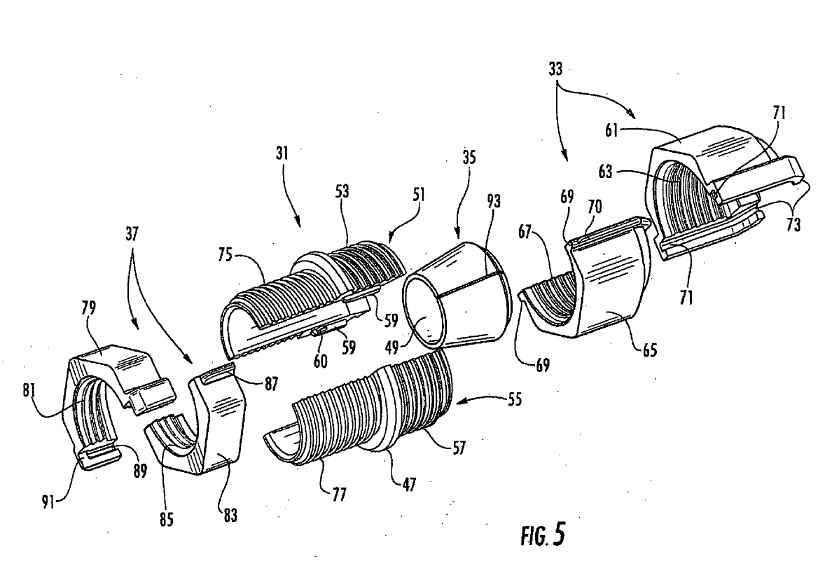

FIGS. 3 and 4 are perspective views of a cable gland 30 in accordance with the present invention. The cable gland 30 generally includes a fitting 31, a compression nut 33, a gland 35 and a retention nut 37.

The fitting 31 includes a first thread track 39 on one end of its outer circumferential surface, which is sized to cooperate with a second thread track 41 on an inside surface of the compression nut 33. The fitting 31 also includes a third thread track 43 on the other end of its outer circumferential surface, which is sized to cooperate with a fourth thread track 45 on an inside surface of the retention nut 37. An outwardly projecting abutment 47 is located proximate a mid-portion of the fitting 31. The fitting 31, compression nut 33 and retention nut 37 are preferably formed of a rigid material, like a plastic, such as nylon, filled nylon, or acrylonitrile-butadiene-styrene (ABS).

In a preferred embodiment, the first thread track 39 is a first screw thread and the second thread track 41 is a second screw thread. Therefore, the compression nut 33 may be moved along the fitting 31 by relative rotation between the compression nut 33 and the fitting 31. Also, the third thread track 43 is a third screw thread and the fourth thread track 45 is a fourth screw thread. Therefore, the retention nut 37 may be moved along the fitting 31 by relative rotation between the retention nut 37 and the fitting 31. The retention nut 37 may be screwed onto the fitting 31 toward the abutment 47, so that a secondary structure can be sandwiched between the retention nut 37 and the abutment 47.

The gland 35 is a generally conical member, sized to fit partially within the fitting 31 and the compression nut 33. The gland 35 includes a bore 49 being centrally located about a longitudinal axis of the conical shape. The gland 35 is preferably formed of an elastic material, such as a thermoplastic elastomer (TPE), rubber, NEOPRENE or Nitrile.

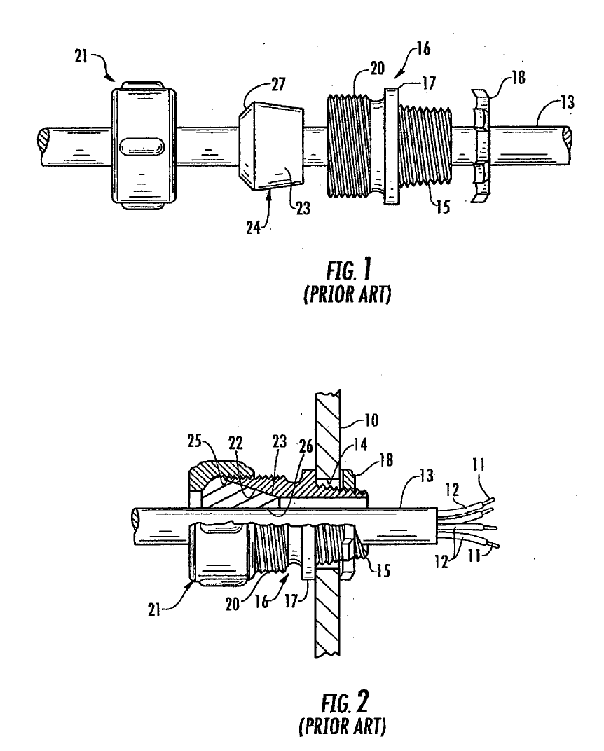

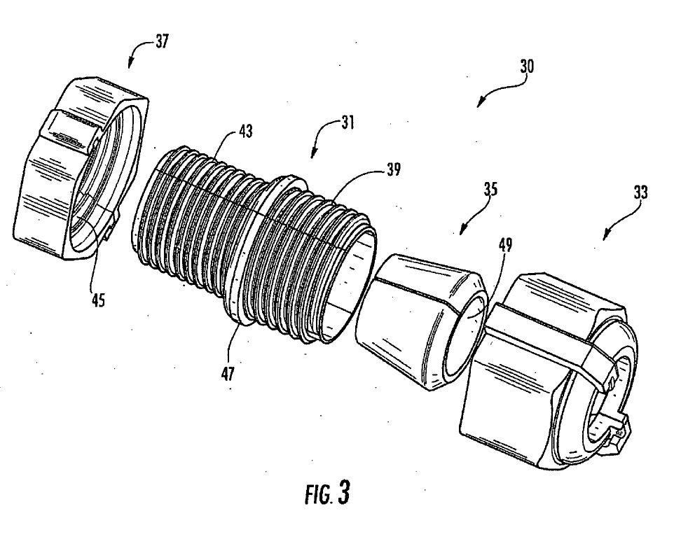

The procedure of the mounting the assembled component parts 31, 33, 35 and 37 of FIGS. 3 and 4 of the cable gland 30 to a secondary structure 10 and to a cable 13 is the same as described in relation to the prior art device of FIGS. 1 and 2. The distinctiveness of the cable gland 30 resides in the construction of one or more of the component parts 31, 33, 35 and 37 of the cable gland 30. Two or more of the component parts 31, 33, 35 and 37 of the cable gland 30 include structural features which enable the cable gland 30 to be installed laterally over a mid-span portion of the cable, as opposed to having to feed a cable through central openings in the component parts 31, 33, 35 and 37. The structural features will be explained in detail in conjunction with the exploded view of FIG. 5.

As illustrated in FIG. 5, the fitting 31 includes at least a first piece 51 with a first threaded portion 53 and a second piece 55 with a second threaded portion 57. The first piece 51 includes one or more tabs 59 protruding therefrom. The second piece 55 includes one or more slots formed therein to receive the tabs 59, when the first piece 51 and the second piece 55 are in a fitting mating position. Preferably, a protrusion 60 is provided on a side edge of at least one of the tabs 59. In the fitting mating position, the protrusion 60 snaps into a recess formed in a side wall of the mating slot to form a detent arrangement, which holds the first and second pieces 51 and 55 together, such that the first and second pieces 51 and 55 may later be separated by a manual force. In the fitting mating position, the first threaded portion 53 cooperates with the second threaded portion 57 to form the first thread track 39.

The compression nut 33 includes at least a third piece 61 with a third threaded portion 63 and a fourth piece 65 with a fourth threaded portion 67. The fourth piece 65 includes one or more tongues 69 protruding therefrom. The third piece 65 includes one or more grooves 71 formed therein to receive the tongues 69 when the third piece 61 and the fourth piece 65 are in a compression nut mating position. The grooves 71 may include stops 73 to abate further movement of the tongues 69 within the grooves 71 when the third and fourth pieces 61 and 65 reach the compression nut mating position. Preferably, a protrusion 70 is provided on an end edge of at least one of the tongues 69. In the compression nut mating position, the protrusion 70 snaps into a recess formed in a bottom wall of the mating groove 71 to form a detent arrangement, which holds the third and fourth pieces 61 and 65 together, such that the third and fourth pieces 61 and 65 may later be separated by a manual force. In the compression nut mating position, the third threaded portion 63 cooperates with the fourth threaded portion 67 to form the second thread track 41.

The first piece 51 of the fitting 31 also includes a fifth threaded portion 75. The second piece 55 of the fitting 31 also includes a sixth threaded portion 77. In the fitting mating position, the fifth threaded portion 75 cooperates with the sixth threaded portion 77 to form the third thread track 43.

The retention nut 37 includes at least a fifth piece 79 with a seventh threaded portion 81 and a sixth piece 83 with an eighth threaded portion 85. Similar to the compression nut 33, the sixth piece 83 includes one or more tongues 87 protruding therefrom. The fifth piece 79 includes one or more grooves 89 formed therein to receive the tongues 87 when the fifth piece 79 and the sixth piece 83 are in a retention nut mating position. The grooves 89 may include stops 91 to abate further movement of the tongues 87 within the grooves 89 when the fifth and sixth pieces 79 and 83 reach the retention nut mating position. A detent mechanism may also be provided between the two pieces 79 and 83 of the retention nut 37 in a same or similar manner as the detent mechanism described in relation to the two pieces 61 and 65 of the compression nut 33. In the retention nut mating position, the seventh threaded portion 81 cooperates with the eighth threaded portion 85 to form the fourth thread track 45.

As best seen in FIG. 5, the gland 35 includes a slit 93 passing from an outer circumferential surface thereof to the bore 49. The gland 35 can be bent to open the slit 93 wide enough to receive a cable. The slit 93 allows a cable to be inserted laterally through the outer circumferential surface of the gland 35 and into the bore 49. In other words, there is no need to feed a cable end longitudinally through the bore 49. The remaining component parts, e.g., the fitting 31, the compression nut 33 and the retention nut 37, can also be assembled laterally around the cable. The two pieces 61 and 65 of the compression nut 33 are slid together along a longitudinal direction of the cable by the tongue 69 and groove 71 arrangements. The two pieces 79 and 83 of the retention nut 37 are also slid together along a longitudinal direction of the cable by the tongue 87 and groove 89 arrangements. The two pieces 51 and 55 of the fitting 31 are plugged together in a direction perpendicular to the longitudinal direction of the cable via the tabs 59 and slots.

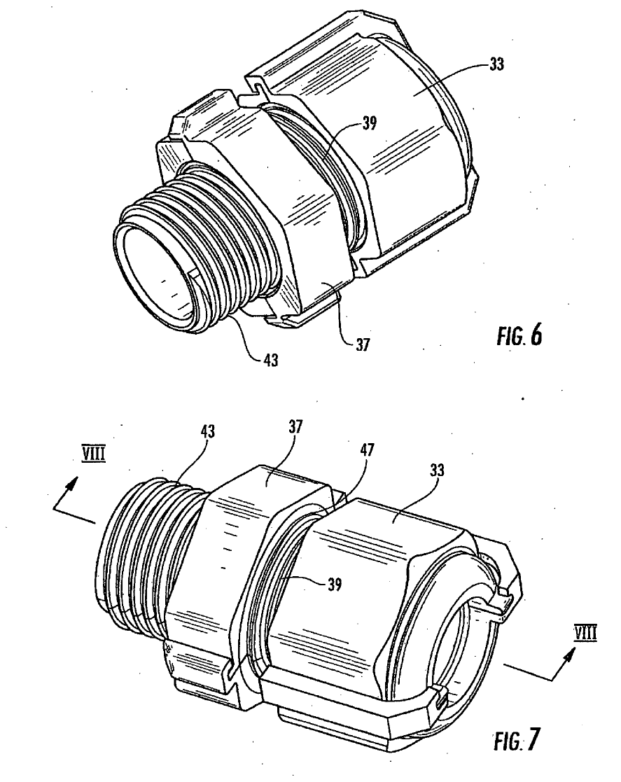

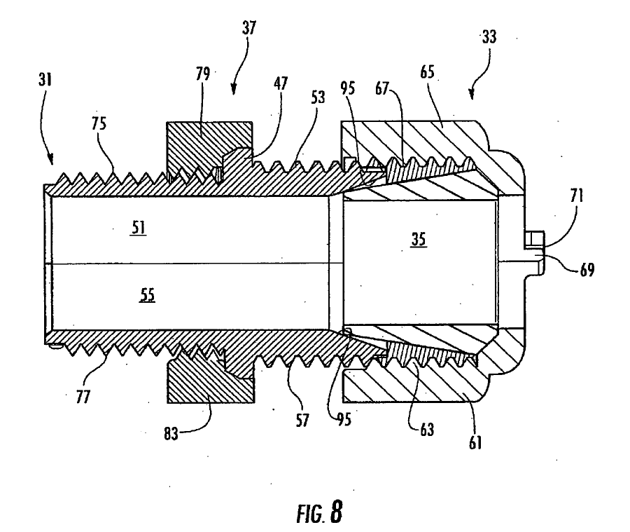

Once the pieces of the component parts of the cable gland 30 are installed around a cable, the component parts are assembled one to another. As illustrated in FIGS. 6 and 7, the second thread track 41 of the compression nut 33 is engaged with the first thread track 39 of the fitting 31. Likewise, the fourth thread track 45 of the retention nut 37 is engaged with the third thread track 43 of the fitting 31.

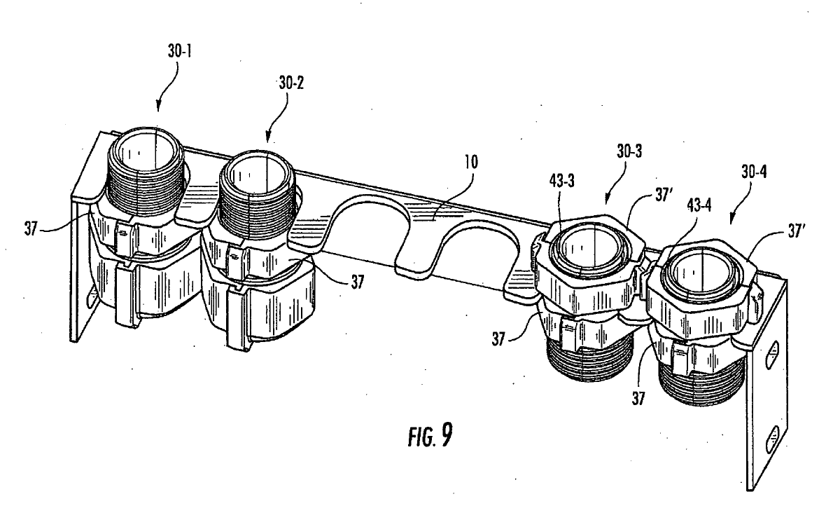

As illustrated in the cross sectional view of FIG. 8, screwing the compression nut 33 onto the fitting 31 while the gland 35 is within the fitting 31 will apply forces to the gland 35. The gland 35 will be placed into a compressed state which constricts a diameter of the bore 49 and causes a frictional engagement with a jacket of a cable passing therethrough. If preferred, the frictional engagement may be made liquid tight by closely matching the shape of the bore to the shape of the jacket. The compression of the gland 35 is caused by a tapering inner surface 95 of the fitting 31. In a preferred embodiment, the internal geometry of the tapering inner surface 95 of the fitting 31 closely matches the outer surface geometry of the gland 35. This prevents the gland 35 from deforming longitudinally, e.g., sliding along the plane of the split 93, during tightening of the compression nut 33 onto the fitting 31.

When the component parts of the cable gland 30 are assembled as illustrated in FIGS. 6-8, the first and second pieces 51 and 55 of the fitting 31 are locked in the fitting mating position due to a surrounding engagement by the compression nut 33 and/or a surrounding engagement by the retention nut 37. In FIGS. 6-8, the third and fourth pieces 61 and 65 of the compression nut 33 are locked in the compression nut mating position because the tongues 69 may not slide longitudinally relative to the grooves 71 due to the engagement between the first thread track 39 and the second thread track 41. Also in FIGS. 6-8, the fifth and sixth pieces 79 and 83 of the retention nut 37 are locked in the retention nut mating position because the tongues 87 may not slide longitudinally relative to the grooves 89 due to the engagement between the third thread track 43 and the fourth thread track 45.

The first and second pieces 51 and 55 of the fitting 31 are free to be separated one from the other when the first and third thread tracks 39 and 43 are free of the compression nut 33 and retention nut 37. The first and second pieces 51 and 55 may be separated by applying a manual force to overcome the detent engagement caused by the protrusion 60. Of course, the detent engagement caused by the protrusion 60 is only optional in the present invention. If no protrusion 60 is provided, the first and second pieces 51 and 55 of the fitting 31 would simply separate when the compression nut 33 and retention nut 37 are freed from the fitting 31. The third and fourth pieces 61 and 65 of the compression nut 33 are free to be separated one from the other when the compression nut 33 is removed from the fitting 31. The third and fourth pieces 61 and 65 may be separated by applying a manual force to overcome the detent engagement caused by the protrusion 70. The fifth and sixth pieces 79 and 83 of the retention nut 37 are free to be separated one from the other when the retention nut 37 is removed from the fitting 31 by applying a manual force to overcome any detent engagement therebetween.

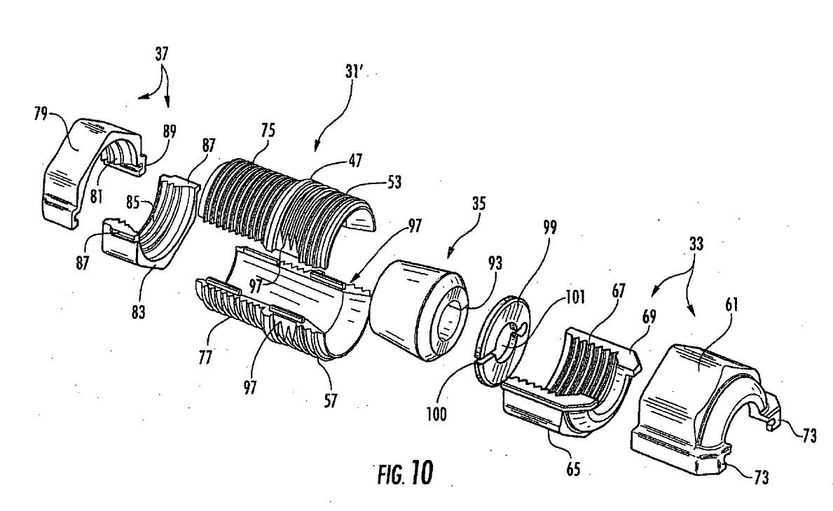

One modification of the present invention would be to remove the abutment 47 of the fitting 31. Instead of using an abutment 47, the cable gland 30 could be attached to a secondary structure 10 by two retention nuts 37 and 37′. FIG. 9 illustrates the optional embodiment. In FIG. 9, first and second cable glands 30-1 and 30-2 are constructed identically to the gland 30 of FIGS. 6-8, except that the first and second cable glands 30-1 and 30-2 do not have an abutment 47. Third and fourth cable glands 30-3 and 30-4 illustrate that second retention nuts 37′ may have their respective fourth thread tracks 45′ engaged to the respective third thread tracks 43-3 and 43-4 of the third and fourth cable glands 30-3 and 30-4. A portion of the secondary structure 10 is sandwiched between the first and second retention nuts 37 and 37′ instead of between a retention nut 37 and the abutment 47.

Although FIGS. 1-9 have illustrated the first through fourth thread tracks 39, 41, 43 and 45 as screw threads, it would be possible to have different structures. For example, the first and third thread tracks 39 and 43 could be parallel outwardly extending rings around the outer circumference of the fitting 31. The second and fourth thread tracks 41 and 45 could be parallel inwardly extending rings, formed on the inner surfaces of the compression nut 33 and the retention nut 37. One or more of the parallel rings of the first and second thread tracks 39 and 41 could be resiliently deformable, so that the compression nut 33 could be press fitted onto the fitting 31 by snapping the rings of the second thread track 41 past the rings of the first thread track 39. Likewise, one or more of the parallel rings of the third and fourth thread tracks 43 and 45 could be resiliently deformable, so that the retention nut 37 could be press fitted onto the fitting 31 by snapping the rings of the fourth thread track 45 past the rings of the second thread track 43.

FIG. 10 illustrates two further modifications to the present invention. A portion of the first thread track 39 may include one or more flat spots 97 on opposing sides of the fitting 31. The flat spots 97 can be engaged by a tool, such as a wrench or pliers so that the fitting 31′ can be prevented from rotating while the compression nut 33 and/or retention nut 37 are screwed off of the fitting 31.

FIG. 10 also illustrates a split washer 99 sized to be disposed between the compression nut 33 and the gland 35. The split washer 99 has a slit 100 and can be twisted open to permit a cable to pass through the slit 100 and into a central opening 101 of the split washer 99. The split washer 99 can be formed of a material, such as polyethylene or polypropylene, to accommodate the living hinge aspect of the washer 99 which permits the slit 100 to be opened. Also, the split washer 99 can be shaped and sized to match the shape and size of the abutting surface of the gland 35. In a preferred embodiment of the invention, the gland 35 has complete backing so that the gland 35 does not deform out of position when the compression nut 33 is torqued onto the fitting 31, which would result in the compression nut 33 not being able to properly thread onto the fitting 31 and/or improper compression of the gland 35. To have complete backing, either the diameter of a bore through the compression nut 33 substantially matches the diameter of the bore 49 through the gland 35, or a split washer 99 is provided so that the opening 101 in the compression nut 33 substantially matches the diameter of the bore 49 through the gland 35. Therefore, by having a variety of split washers 99 with differently sized openings 104 but a common outer diameter and a variety of glands 35 with differently sized bores 49, a technician can carry a single size of fittings 31 and a single size of compression nuts 33 and be able to install cable glands 30 onto cables of differing diameters.

Although the foregoing discussion has focused primarily on the use of the cable gland 30 with a fiber optic cable, it should be appreciated that the cable gland 30 could also work in combination with other cables, such as a coaxial cable, a jacketed twisted pair cable, a jacketed composite cable or a power cable. Although continuous thread tracks 39, 41, 43 and 45 have been illustrated, discontinuous thread tracks could be employed with brief gaps existing all along the thread track to conserve material costs and reduce the amount of material present to produce smoke in the case of a fire. Further, the thread tracks along the parting lines of a component (e.g., fitting, compression nut) could be removed. In other words, where the thread tracks of the two pieces of a component part come together, the thread tracks could be removed to prevent flash from entering the thread region and not allowing the compression nut 33 to screw onto the fitting 31. In the case of the fitting 31, this would basically be an extension of the flat spots 97 along the entire length of the fitting 31 along the seam between the two parts forming the fitting 31. Although a two piece retention nut 37 has been illustrated, the retention nut 37 could be replaced by a u-shaped clip which is screwed onto the second thread track 43 to sandwich a secondary structure between the u-shaped clip and the abutment 47. Although the bore 49 through the gland 35 has been illustrated with a circular cross sectional shape, the bore 49 could have other cross sectional shapes (e.g., oval), so that the cable gland could function with cables or other objects having outer cross sectional shapes other than circular, which match the cross sectional shape of the bore 49.

Although FIGS. 3-10 have illustrated the first thread track 39 on an outer circumferential surface of the fitting 31 and the second thread track 41 on an inner surface of the compression nut 33, the male-female relationship could be reversed. In other words, the first thread track 39 could be provided on an inner surface of the fitting 31 and the second thread track 41 could be provided on an outer circumferential surface of the compression nut 33.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A cable gland comprising:
a fitting having at least a first piece with a first threaded portion and a second piece with a second threaded portion, wherein said first piece can be moved relative to said second piece to a fitting mating position such that said first threaded portion cooperates with said second threaded portion to form a first thread track;
a compression nut having at least a third piece with a third threaded portion and a fourth piece with a fourth threaded portion, wherein said third piece can be moved relative to said fourth piece to a compression nut mating position such that said third threaded portion cooperates with said fourth threaded portion to form a second thread track; and
a gland sized to fit at least partially within at least one of said compression nut and said fitting, said gland having a bore passing therethrough, wherein when said second thread track of said compression nut is engaged with said first thread track of said fitting and said compression nut is moved onto said fitting while said gland is at least partially within said fitting, said gland will be placed into a compressed state which constricts a diameter of said bore.

2. The cable gland according to claim 1, wherein said first and second pieces are held locked in said fitting mating position when said second thread track of said compression nut is engaged with said first thread track of said fitting.

3. The cable gland according to claim 2, wherein said first and second pieces are free to be separated one from the other when said second thread track of said compression nut is disengaged from said first thread track of said fitting.

4. The cable gland according to claim 1, wherein said third and fourth pieces are held locked in said compression nut mating position when said second thread track of said compression nut is engaged with said first thread track of said fitting.

5. The cable gland according to claim 4, wherein said third and fourth pieces are free to be separated one from the other when said second thread track of said compression nut is disengaged from said first thread track of said fitting.

6. The cable gland according to claim 1, wherein said first piece includes at least one tab protruding therefrom and said second piece includes at least one slot formed therein to receive said at least one tab when said first and second pieces are in said fitting mating position.

7. The cable gland according to claim 1, wherein said fourth piece includes at least one tongue protruding therefrom and said third piece includes at least one groove formed therein to receive said at least one tongue when said third and fourth pieces are in said compression nut mating position.

8. The cable gland according to claim 1, wherein said gland is formed of an elastic material and has a generally conical shape with said bore being centrally located about a longitudinal axis of the conical shape.

9. The cable gland according to claim 8, wherein said gland includes a slit passing from an outer circumferential surface thereof to said bore to permit insertion of a cable through said outer circumferential surface and into said bore.

10. The cable gland according to claim 1, wherein said first piece also includes a fifth threaded portion and said second piece also includes a sixth threaded portion, and when said first and second pieces are in said fitting mating position, said fifth threaded portion cooperates with said sixth threaded portion to form a third thread track, and further comprising:
a retention nut having at least a fifth piece with a seventh threaded portion and a sixth piece with an eighth threaded portion, wherein said fifth piece can be moved relative to said sixth piece to a retention nut mating position such that said seventh threaded portion cooperates with said eighth threaded portion to form a fourth thread track, wherein said fourth thread track is sized to engage with said third thread track of said fitting.

11. The cable gland according to claim 10, wherein said fifth and sixth pieces are held locked in said retention nut mating position when said fourth thread track of said retention nut is engaged with said third thread track of said fitting.

12. The cable gland according to claim 11, wherein said fifth and sixth pieces are free to be separated one from the other when said fourth thread track of said retention nut is disengaged from said third thread track of said fitting.

13. The cable gland according to claim 10, wherein said fitting includes an outwardly projecting abutment proximate a mid-portion thereof, and wherein said retention nut is sized to be moved toward said abutment to sandwich a structure between said retention nut and said abutment.

14. The cable gland according to claim 10, wherein said retention nut is a first retention nut, and further comprising:
a second retention nut having at least a seventh piece with a ninth threaded portion and a eighth piece with a tenth threaded portion, wherein said seventh piece can be moved relative to said eighth piece to a second retention nut mating position such that said ninth threaded portion cooperates with said tenth threaded portion to form a fifth thread track, wherein said fifth thread track of said second retention nut is sized to engage with said third thread track of said fitting and said second retention nut is sized to be moved along said fitting in a direction toward said first retention nut to sandwich a structure between said first retention nut and said second retention nut.

15. The cable gland according to claim 1, wherein said first thread track is a first screw thread, said second thread track is a second screw thread, and said compression nut may be moved onto said fitting by relative rotation between said compression nut and said fitting.

16. The cable gland according to claim 15, wherein said first screw thread is formed on an outer circumferential surface of said fitting, and said second screw thread is formed on an inner surface of said compression nut.

17. The cable gland according to claim 15, further comprising:
a plurality of flat spots formed along portions of said first screw thread for engagement by tool.

18. The cable gland according to claim 10, wherein said third thread track is a third screw thread formed on an outer circumferential surface of said fitting, said fourth thread track is a fourth screw thread formed on an inner surface of said retention nut, and said retention nut may be moved onto said fitting by relative rotation between said retention nut and said fitting.

19. The cable gland according to claim 1, further comprising:
a split washer sized to be disposed between said compression nut and said gland.

20. The cable gland according to claim 19, wherein said split washer has a central opening with a diameter substantially the same as a diameter of said bore passing through said gland.

21. A cable gland comprising:
a two-piece fitting sized to be laterally assembly over a cable; and
a two-piece compression nut sized to be laterally assembly over the cable, wherein said two pieces of said compression nut are slid together along a longitudinal direction of the cable by a tongue and groove arrangement, and said two pieces of said fitting are plugged together in a direction perpendicular to the longitudinal direction of the cable.

22. The cable gland according to claim 21, wherein said fitting includes first threads, said compression nut includes second threads, sized to mate with said first threads.

23. The cable gland according to claim 22, wherein once said first threads are engaged to said second threads, said two-piece fitting is locked together by a surrounding engagement by said compression nut, and said two-piece compression nut is locked together such that said tongue may not slide longitudinally relative to said groove due to the engagement of said first threads and said second threads.

24. A method of assembling a cable gland on a cable comprising:
engaging first and second pieces laterally around a mid-span portion of a cable to form a fitting;
engaging third and fourth pieces laterally around a mid-span portion of the cable to form a compression nut;
inserting a gland on a mid-span portion of the cable between the fitting and compression nut; and
attaching the compression nut to the fitting to compress the gland against a jacket of the cable.

25. The method of claim 24, wherein said step of engaging the third and fourth pieces includes moving the third and fourth pieces together in a direction parallel a longitudinal extension direction of the cable.

26. The method of claim 25, wherein said step of engaging the first and second pieces includes moving the first and second pieces together in a direction perpendicular to the longitudinal extension direction of the cable.

27. The method of claim 26, wherein said step of inserting the gland on the mid-span portion of the cable includes pushing the mid-span portion of cable through a slit in a side wall of the gland and into a central bore of the gland.
